(19) United States
(12) Patent Application Publication
(10) Pub. No.: US 2017/0221109 A1
(43) Pub. Date: Aug. 3, 2017

(54) ADS MANAGEMENT IN A BROWSER APPLICATION

(71) Applicant: QUALCOMM Incorporated, San Diego, CA (US)

(72) Inventors: Bojin Liu, San Diego, CA (US); Enrico Ros, San Diego, CA (US); Kulanthaivel Palanichamy, San Diego, CA (US)

(21) Appl. No.: 15/010,673

(22) Filed: Jan. 29, 2016

(51) Int. Cl. G06Q 30/02

(52) U.S. Cl. CPC G06Q 30/0272; G06Q 30/0277

(57) ABSTRACT

An example method of managing ads in a browser application includes receiving a request to load a webpage referenced by a uniform resource locator (URL). The webpage includes a set of ads, and each ad of the set of ads includes one or more ad resources. The method also includes searching a browser cache for a set of cached ads associated with the URL. The browser application caches ads included in one or more webpages into the browser cache. The method further includes composing an ads page including at least one cached ad of the set of cached ads and displaying the ads page on a client device.

### FIELD OF DISCLOSURE

The present disclosure generally relates to data transmission over a network, and more particularly to managing ads included in a webpage.

### BACKGROUND

Mobile devices are ubiquitous and may include a smartphone, tablet, portable digital assistant (PDA), portable game console, palmtop computer, and other portable electronic devices. In addition to the primary function of these devices, many include peripheral functions. For example, a smartphone may include the primary function of making telephone calls and the peripheral functions of playing a game, a still camera, a video camera, global positioning system (GPS) navigation, sending and receiving emails, and Web browsing.

A user may encounter annoyances while browsing the Web. For example, online ads may appear in webpages requested by the user. This may negatively affect the user experience especially if she is on a mobile device because the online ads result in additional traffic and were not requested by the user, but may still count toward the user's data cap. Additionally, loading the webpage may take more time because the ads may slow down the rendering of the webpage. A conventional technique to prevent ads from being displayed in webpages is to use an ad blocker. Although the use of an ad blocker is a popular solution to prevent ads from being displayed in webpages, ad blockers also have drawbacks. For example, some ads may actually be relevant and useful. Additionally, blocking all ads may lead to “breaking the Internet” monetarily, as online ads are often one of the main sources of revenue for companies doing business online.

Another annoyance users may face is being shown a blank white screen at the beginning of each webpage load. Loading websites on a mobile device may be slow, and while loading, users typically are shown a blank white screen for a few seconds before anything shows up. A blank white screen provides no useful information to the user and may further be a waste of time and also power as it may cost more in terms of power to display than a screen with colored pixels.

### BRIEF SUMMARY

This disclosure relates to managing ads that are displayed in webpages and may provide a user with an improved user experience while still preserving the model of online ads rather than destroying them altogether. Methods, systems, and techniques for managing and displaying ads are provided.

According to some embodiments, a method of managing ads in a browser application includes receiving, by a browser application on a client device, a request to load a webpage referenced by a uniform resource locator (URL). The webpage includes a set of ads. The method also includes searching a browser cache for a set of cached ads associated with the URL. The browser application caches ads included in one or more webpages into the browser cache. The method further includes composing an ads page including at least one cached ad of the set of cached ads. The method also includes displaying the ads page on a client device.

According to some embodiments, a system for managing ads in a browser application includes a rendering engine that receives a request to load a webpage referenced by a URL. The webpage includes a set of ads. The system also includes a browser cache that stores ads included in one or more requested webpages. The system further includes an ads pre-composer that searches the browser cache for a set of cached ads associated with the URL and composes an ads page including at least one cached ad of the set of cached ads. The rendering engine displays the ads page on a client device.

According to some embodiments, a computer-readable medium has stored thereon computer-executable instructions for performing operations including: receiving, by a browser application on a client device, a request to load a webpage referenced by a URL, the webpage including a set of ads; searching a browser cache for a set of cached ads associated with the URL, the browser application caching ads included in one or more webpages into the browser cache; composing an ads page including at least one cached ad of the set of cached ads; and displaying the ads page on a client device.

According to some embodiments, an apparatus for managing ads in a browser application includes means for receiving a request to load a webpage referenced by a URL, the webpage including a set of ads. The apparatus also includes means for searching a browser cache for a set of cached ads associated with the URL in response to the request to load the webpage, a browser application caching ads included in one or more webpages into the browser cache. The apparatus further includes means for composing an ads page including at least one cached ad of the set of cached ads. The apparatus also includes means for displaying the ads page on a client device.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a system for managing ads in a browser application in accordance with one or more embodiments.

FIG. 2 is an example of a webpage including ads in accordance with one or more embodiments.

FIG. 3 is a swim diagram illustrating the storage of ads into a browser cache in accordance with one or more embodiments.

FIG. 4 is a swim diagram illustrating the display of cached ads before the requested webpage is displayed in accordance with one or more embodiments.

FIG. 5 is a composed ads page illustrating the display of cached ad content in accordance with one or more embodiments.

FIGS. 6A and 6B are swim diagrams illustrating the refreshing of ads stored in the browser cache in accordance with one or more embodiments.

FIG. 7 is a composed ads page illustrating the display of updated cached ad content in accordance with one or more embodiments.

FIG. 8 is a flowchart illustrating a method of managing ads in a browser application in accordance with one or more embodiments.

FIG. 9 is a block diagram of a computer system suitable for implementing one or more embodiments of the present disclosure.

### DETAILED DESCRIPTION

### I. Overview

### II. Example System Architecture

### III. Manage the Ads Included in a Webpage

A. Identify Ads Included in a Webpage

B. Display the Cached Ads before Displaying the Requested Webpage

C. Update the Browser Cache
1. Refresh the Ads in the Browser Cache
2. Remove the Expired Ads from the Browser Cache

### IV. Example Methods

### V. Example Computing System

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

An ad displayed in a webpage may be a live ad or a cached ad. A “live ad” refers to ad content that is retrieved dynamically over the network. For example, an ad may be included in a webpage and specify one or more references (e.g., a URL) where resources of the ad are stored. A browser application may parse the webpage and identify the URL(s) where the ads included in the webpage are stored. The browser application may send a request over the network for the live ad to the server(s) that host(s) the ad and receive over the network the live ad from the server(s). The browser application may retrieve the live ad from the server(s) and render the ad to the display. The browser application may also store the live ad into a browser cache for later retrieval.

An ad stored in the browser cache may be referred to as a cached ad. If the browser application receives a webpage in response to a request, the browser application may request from the appropriate servers the ad resources included in the webpage. If an ad resource is stored in the browser cache, the browser application may retrieve from the browser cache the appropriate cached ad associated with the webpage rather than request the ad from the server(s) storing the ad.

It may be time consuming for a browser application to retrieve live ads over a network to render them for display. For example, some webpages may have a large number of ads that may take a while for the browser application to download and render onto a display. Additionally, the display of live ads may result in expensive, additional traffic for the client device. For example, the additional ad traffic may count toward a user data cap and be especially annoying for the user because she did not opt to pay for the additional ad traffic.

Moreover, while the browser application dynamically retrieves the live ads over the network, the display may show a blank white screen. The display of a white screen provides no useful information to a user and be a waste of time and power. For example, a white screen may cost more power to display compared to a page with color because every pixel is lit fully. It may take from 500 milliseconds (ms) to a couple of seconds before any content is displayed on the display. This amount of time is long enough to be recognized and capture the user's attention, thus reducing the user's experience because she is viewing a white screen, unable to do anything but wait for display of the webpage content. The user may be forced to endure a “blank moment” short enough such that the user would not switch to other activities.

Moreover, the browser application may delay loading a webpage while content (ad content and non-ad content) of the webpage is retrieved and processed, thus resulting in an unacceptable user experience. An ad blocker may be insufficient for resolving these problems because while it may prevent the additional ad traffic from passing through to the client device, all ads will be prevented from being displayed. For example, the user may be interested in relevant ads that will not be displayed if an ad blocker is operating. Blocking such relevant ads may not be in the best interests of the user. Additionally, a significant portion of the e-commerce industry relies on online ads for revenue. If ad blockers are massively adopted, it may to some extent “break the Internet” monetarily.

The present disclosure describes techniques for overcoming one or more of these disadvantages. For example, an embodiment of the disclosure may reduce the bandwidth and power consumption in the browser application and/or provide a better user experience for the user by making use of the “white screen time” while a webpage is loading to display locally cached ads on the screen. “White screen time” refers herein to the time duration in which the display would normally show a white screen while the webpage is loading. The “time to first pixel” or “time to first paint” may refer to a time duration that starts when the browser application initiates loading of a webpage and ends when a first pixel is painted onto the display. As such, the phrases “time to first pixel” and “time to first paint” may be used interchangeably in the present disclosure. Before the first pixel is painted onto the display, the display may show a white screen. The time duration in which the white screen is displayed may be referred to as the “white screen time.” It usually desirable to shrink the time to first pixel as much as possible and bring it as close as possible to zero. The present disclosure provides techniques for shrinking the time to first pixel over conventional techniques.

A browser application may collect information about the ads included in the webpages. In some embodiments, the browser application includes an ads manager that manages ads, caches ads included in the webpages, and reorganizes them in an ads page. In response to a request to load a webpage, the ads manager may determine whether cached ads associated with the webpage are stored in a browser cache including the cached ads. If there are any cached ads associated with the webpage stored in the browser cache, the ads manager may display the cached ads during the conventional white screen time rather than displaying a white screen. Additionally, cached ads may be used in place of live ads originally included in the webpage. If a requested webpage is ready for display to the user, the browser application may display the webpage without ads or with ads embedded in the webpage. The webpage may be loaded faster because fewer resources are loaded to complete the webpage. Moreover, the present disclosure may provide for a client-only solution in which it would be unnecessary for Web developers to change their website because, for example, the functionality of the ads manager may be deployed at the client device.

Unless specifically stated otherwise, as apparent from the following discussion, it will be appreciated that throughout the description, discussions utilizing terms such as “determining,” “receiving,” “sending,” “searching,” “composing,” “displaying,” “fetching,” “pre-fetching,” “parsing,” “identifying,” “storing,” “associating,” “retrieving,” “detecting,” “refreshing,” “time stamping,” “purging,” or the like, refer to an action or process of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

### II. Example System Architecture

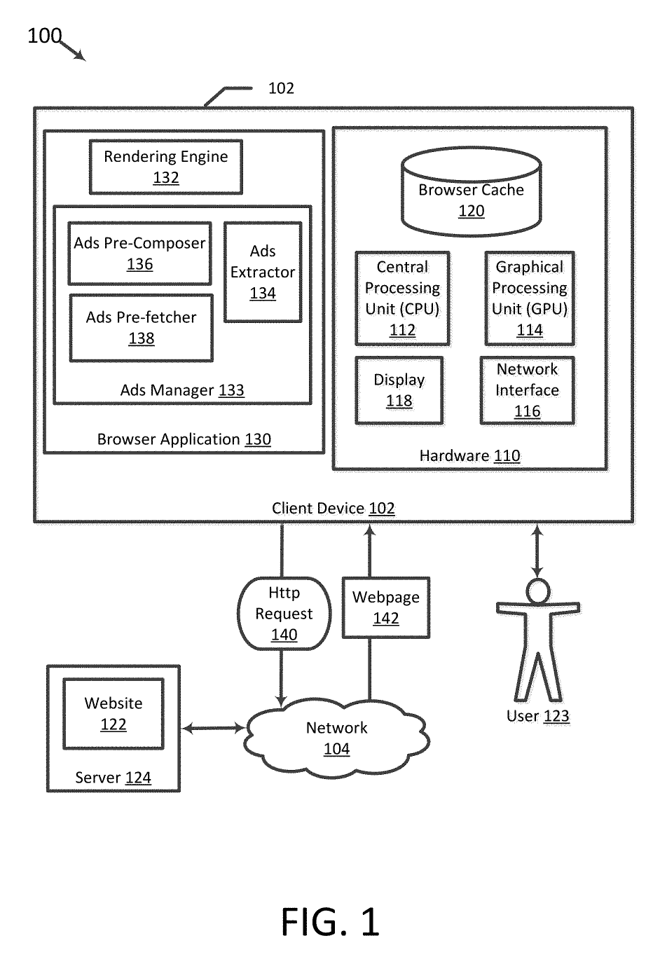

FIG. 1 is a block diagram 100 illustrating a system for managing ads in a browser application in accordance with one or more embodiments. A client device 102 communicates over a network 104 with one or more servers 124. Network 104 may include various technologies and protocols including the Internet, World Wide Web, intranets, virtual private networks, wide area networks, local networks, private networks using communication protocols proprietary to one or more companies, cellular and other wireless networks, Internet relay chat channels (IRC), instant messaging, simple mail transfer protocols (SMTP), Ethernet, Wi-Fi and Hypertext Transfer Protocol (HTTP), and various combinations of the foregoing.

Client device 102 may refer to a stationary computing device (e.g., desktop) or a non-stationary computing device (e.g., a smartphone, tablet, laptop, or personal digital assistant (PDA)). Client device 102 includes hardware 110, which includes one or more central processing units (CPUs) 112, one or more graphics processing units (GPUs) 114, a network interface 116, a display 118, and a browser cache 120. Hardware 110 may also include other devices. A “CPU” may also be referred to as a “hardware processor,” “physical processor,” or “processor” herein. A CPU shall also refer to a device capable of executing instructions encoding arithmetic, logical, or input/output (I/O) operations. In an illustrative example, a CPU may follow the Von Neumann architectural model and may include an arithmetic logic unit (ALU), a control unit, and a plurality of registers.

CPU 112 may include a general-purpose or a special-purpose processor that controls operation of client device 102. A user may provide input to client device 102 to cause CPU 112 to execute one or more software applications. The software applications that execute on CPU 112 may include, for example, an operating system, a software application (e.g., browser application 130, a word processor application, an email application, a spread sheet application, a video game application, a graphical user interface (GUI) application), or another program. A user 123 of client device 102 may provide input to the client device via one or more input devices (not shown) such as a keyboard, a mouse, a microphone, a touch pad or another input device that is coupled to client device 102 via a user interface.

In a further aspect, a CPU may be a single core CPU that is typically capable of executing one instruction at a time (or process a single pipeline of instructions), or a multi-core CPU that may simultaneously execute multiple instructions. In another aspect, a CPU may be implemented as a single integrated circuit, two or more integrated circuits, or may be a component of a multi-chip module (e.g., in which individual microprocessor dies are included in a single integrated circuit package and hence share a single socket).

Client device 102 may be equipped with one or more high-performance GPUs 114 providing high performance with regard to computations and graphics rendering. To process the graphics rendering instructions, CPU 112 may issue one or more graphics rendering commands to GPU 114 to cause GPU 114 to perform some or all of the rendering of the graphics data. GPU 114 may, in some instances, be built with a highly-parallel structure that provides more efficient processing of vector operations than CPU 112. Client device 102 may use GPU 114 to accelerate the rendering of graphics data for display. Client device 102 may include a client application (e.g., browser application 130) that executes on CPU 112 and/or GPU 114.

GPU 114 may, in some instances, be integrated into a motherboard of client device 102. In other instances, GPU 114 may be present on a graphics card that is installed in a port in the motherboard of client device 102 or may be otherwise incorporated within a peripheral device configured to interoperate with client device 102. In further instances, GPU 114 may be located on the same microchip as CPU 112 forming a system on a chip (SoC). GPU 114 may include one or more processors, such as one or more microprocessors, application specific integrated circuits (ASICs), field programmable gate arrays (FPGAs), digital signal processors (DSPs), or other integrated or discrete logic circuitry.

Display 118 may be integrated within client device 102. For example, display 118 may be a screen of client device 102. Alternatively, display 118 may be a stand-alone device coupled to client device 102 via a wired or wireless communications link. For example, display 118 may be a computer monitor or flat panel display coupled to client device 102 via a cable or wireless link.

Client device 102 may include one or more applications, for example, to provide client-side processing for performing desired tasks in response to operations selected by user 123. For example, browser application 130 may be hosted on client device 102 and used for retrieving, presenting, and traversing information resources provided by servers (e.g., Web servers on the World Wide Web). An information resource is identified by a uniform resource identifier (URI) and may be a webpage, image, video, client-side scripts, and/or other piece of content. The information resource may be referenced by a uniform resource location (URL) that specifies the location where the information resource is stored. Browser application 130 may provide an interface permitting user 123 to browse information available over network 104. Browser application 130 may be represented by an icon on display 118, and user 123 of client device 102 may select browser application 130 by touching the icon (e.g., double-tapping the icon) to access and interact with websites and resources over network 104. As an example, browser application 130 may be implemented as a Web browser configured to view information available over the Internet.

In FIG. 1, user 123 may use browser application 130 to access data over network 104 from a server 124, which may be a Web server that hosts website 122. A website is a set of related webpages typically served from a single Web domain. Network interface 116 may receive data from and send data to server 124 over network 104. User 123 may point browser application 130 at website 122 by, for example, typing a URL of website 122 into an address bar of browser application 130. For example, client device 102 may send an HTTP request 140 for a webpage 142 of website 122. In response to HTTP request 140, server 124 may send webpage 142 to client device 102. Browser application 130 may receive webpage 142 from server 124.

Client device 102 is capable of executing browser application 130 and storing application data. Browser application 130 may use browser cache 120, which is located on client device 102, to store data in browser cache 120 for quick retrieval. For example, rather than send requests for data (e.g., a resource referenced by a URL) to a server (such as server 124) hosting the data, browser application 130 may retrieve the data, if cached, from browser cache 120.

Browser application 130 includes a rendering engine 132 and an ads manager 133. Rendering engine 132 may render data to display 118 for viewing by user 123. Ads manager 133 manages ads that are received over network 104. Ads manager 133 includes an ads extractor 134, ads pre-composer 136, and ads pre-fetcher 138. When rendering engine 132 renders webpage 142 to display 118, rendering engine 132 may also render one or more ads included in the webpage to display 118. An ad may include one or more resources (e.g., images, video, text, interactive code, etc.) and is associated with a URL of the webpage in which the ad is included. A resource of an ad may be referred to as an “ad resource,” which may be referenced by a URL that identifies a location where the ad resource is stored. Additionally, a URL that references an ad resource may be referred to as an “ad URL.” Ads manager 133 may store an ad resource in browser cache 120.

An ad displayed in a webpage may be a live ad or a cached ad. A “live ad” refers to ad content that is retrieved dynamically over network 104. For example, an ad may be included in webpage 142 loaded from server 124 and specify one or more references (e.g., a URL) indicating where resources of the ad are stored. Browser application 130 may parse webpage 142 and identify the ad URL(s) where the ads included in the webpage are stored. An ad resource may be stored at server 124 or another server. In an example, an ad includes a first ad resource (e.g., a video) that is referenced by a first URL and includes a second ad resource (e.g., text) that is referenced by a second URL. The first and second URLs may be the same, or they may be different from each other. Browser application 130 may send a request over network 104 for the live ad to the appropriate server(s) storing the ad and receive over network 104 the live ad from the server(s). Browser application 130 may receive the live ad and render it onto display 118. Browser application 130 may also store the live ad into browser cache 120 for later retrieval.

An ad stored in browser cache 120 is referred to as a cached ad. As discussed, if browser application 130 receives webpage 142 in response to HTTP request 140, rendering engine 132 may request from the appropriate servers the ad resources included in the webpage. If an ad resource is stored in browser cache 120, however, rendering engine 132 may retrieve from browser cache 120 the appropriate cached ad associated with the webpage rather than request the ad from the server(s) storing the ad.

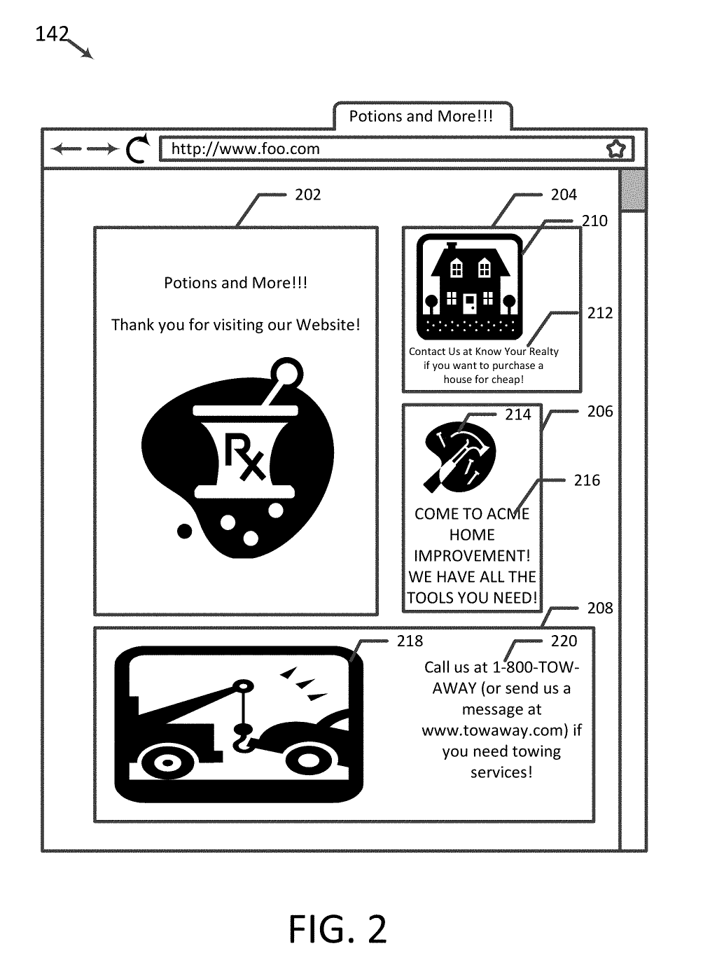

FIG. 2 is an example of webpage 142 displayed on display 118 in accordance with one or more embodiments. In FIG. 2, webpage 142 is referenced by a URL “www.foo.com” and includes non-ad content 202 and ads 204, 206, and 208. Non-ad content 202 may be content that is part of website 122 and that user 123 is interested in viewing. The ads included in webpage 142 may be generated by websites that are not part of website 122 but are nonetheless included in webpages of website 122. The ads included in webpages of website 122 may be stored at server 124 or another server. Browser application 130 may parse webpage 142 to identify references (e.g., links) to resources of the ads (e.g., images, text, metadata of the ads, etc.) included in the webpage and retrieve each of the ad resources.

In the example illustrated in FIG. 2, ad 204 includes two resources, an image 210 and text 212. Additionally, ad 204 is associated with metadata that specifies the “look and feel” of the ad. For example, the metadata of ad 204 may specify the dimensions or size (e.g., length, width, etc.), format, position and/or location within the webpage, scale, code, resolution, color, etc. of one or more resources of the ad. In an example, if an ad is an interactive ad including a client-side script (e.g., JavaScript code), ads extractor 134 may also store the code of the client-side script into browser cache 120. Ad 206 also includes two resources (an image 214 and text 216) and is associated with metadata that specifies a “look and feel” of the ad. Ad 208 also includes two resources (an image 218 and text 220) and is associated with metadata that specifies a “look and feel” of the ad. Ads manager 133 may store the ad resources included in ad 206 and/or ad 208 in browser cache 120.

### III. Manage the Ads Included in a Webpage

### A. Identify Ads Included in a Webpage

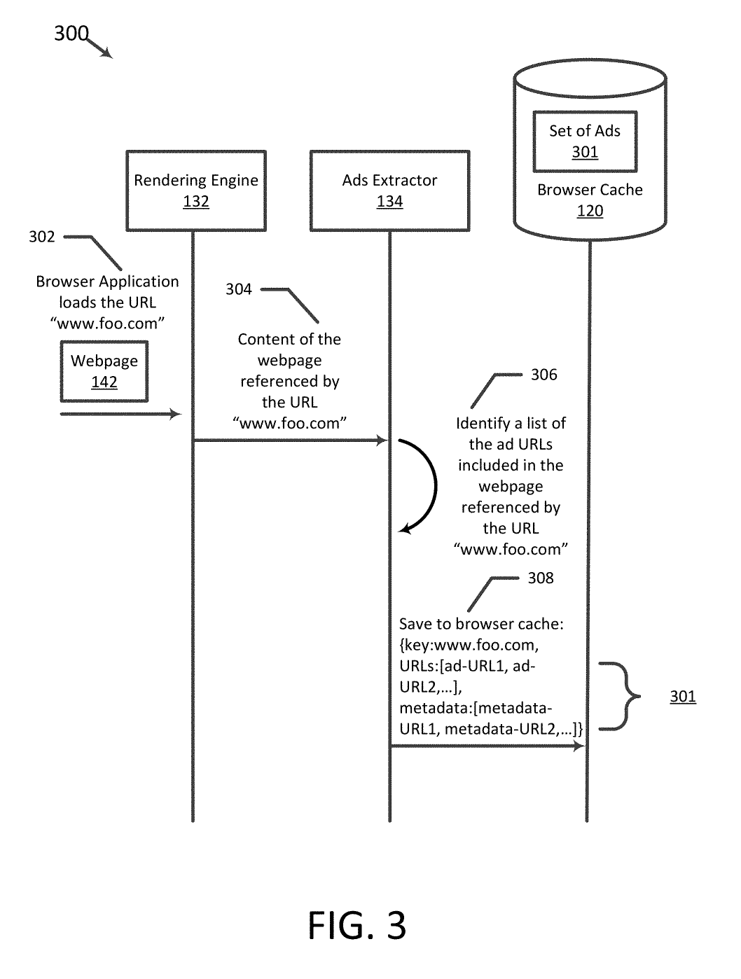

Ads manager 133 may collect information about and manage ads that are to be displayed in a webpage. FIG. 3 is a swim diagram 300 illustrating the storage of ads into a browser cache in accordance with one or more embodiments. In the example illustrated in FIG. 3, at an action 302, browser application 130 loads the URL “www.foo.com.” In an example, webpage 142 is referenced by the URL “www.foo.com.” In response to user 123 pointing browser application 130 to the URL, browser application 130 may load the URL, and rendering engine 132 may receive information for rendering content of webpage 142. Although the present disclosure may describe ads extractor 134 as storing ads from a webpage 142 into browser cache 120, it should be understood that ads extractor 134 may store ads from one or more webpages into browser cache 120 that originated from websites residing on servers other than website 122 on server 124.

At an action 304, rendering engine 132 may inform ads extractor 134 that webpage 142 is being loaded by sending content of webpage 142 to ads extractor 134. Ads extractor 134 may receive content of webpage 142, which is referenced by the URL “www.foo.com.” Ads extractor 134 may analyze the webpage by parsing it to identify ads in the webpage. Ads extractor 134 may identify ads in a variety of ways. In some examples, ads extractor 134 uses heuristics to identify ads included in a webpage. In some examples, a combination of the host name or key word(s) is used to identify ads included in the webpage. In some examples, webpage 142 is a hypertext markup language (HTML) document that includes tags that identify ads included in the webpage. In some examples, the webpage includes a client-side script and ads extractor 134 analyzes the client-side script to identify ads included in the webpage. The client-side script may be written in, for example, JavaScript. In some examples, ads extractor 134 maintains a white list or a black list of URLs for URL pattern matching, terms, keywords, etc. that indicates whether a resource included in a webpage is an ad.

At an action 306, ads extractor 134 identifies a list of ad URLs included in the webpage referenced by the URL “www.foo.com.” A URL of an ad may be referred to as an ad URL and may specify a location where one or more ad resources of the ad are stored. At an action 308, ads extractor 134 stores the URL of the webpage and the identified ad(s) (e.g., ad URL and metadata of the ad(s)) into browser cache 120, and associates the URL of the webpage with the ad(s) included in the webpage. A URL is associated with one or more ads if they are included in the same entry in browser cache 120. Ads extractor 134 stores the URL “www.foo.com” and a set of ads 301, which includes the ad URLs specified in webpage 142 (e.g., URL of ad 204, URL of ad 206 and metadata of set of ads 301, and/or URL of ad 208), into browser cache 120. In an example, referring to FIG. 2, an URL of ad 204 may include a first ad URL that references image 210 and a second ad URL that references text 212.

In the example illustrated in FIG. 3, ads extractor 134 stores “{key:www.foo.com, URLs: [ad-URL1, ad-URL2, . . . ], metadata: [metadata-URL1, metadata-URL2, . . . ]}” into browser cache 120 for later retrieval. In this example, the URL “www.foo.com” is associated with the ad URLs “ad-URL1,” “ad-URL2,” . . . , etc, and each of the ads is associated with metadata that indicates a “look and feel” of the ad. By storing metadata of an ad, ads extractor 134 knows the characteristics of the ad content such that browser application 130 may later reconstruct the ad. Actions 302, 304, 306, and/or 308 may be performed each time browser application 130 loads a webpage. Ads extractor 134 may continue to identify and store one or more ads included in one or more webpages into browser cache 120.

B. Display the Cached Ads before Displaying the Requested Webpage

If user 123 requests a webpage, the ads or a version of the ads included in the webpage may or may not be stored in browser cache 120. If ads associated with the webpage are stored in browser cache 120, it may be quicker during a subsequent display of the webpage to retrieve the cached ads from browser cache 120 rather than retrieve the corresponding live ads over network 104. Additionally, it may be desirable to display the cached ads while the webpage is loading to make use of the conventional white screen time.

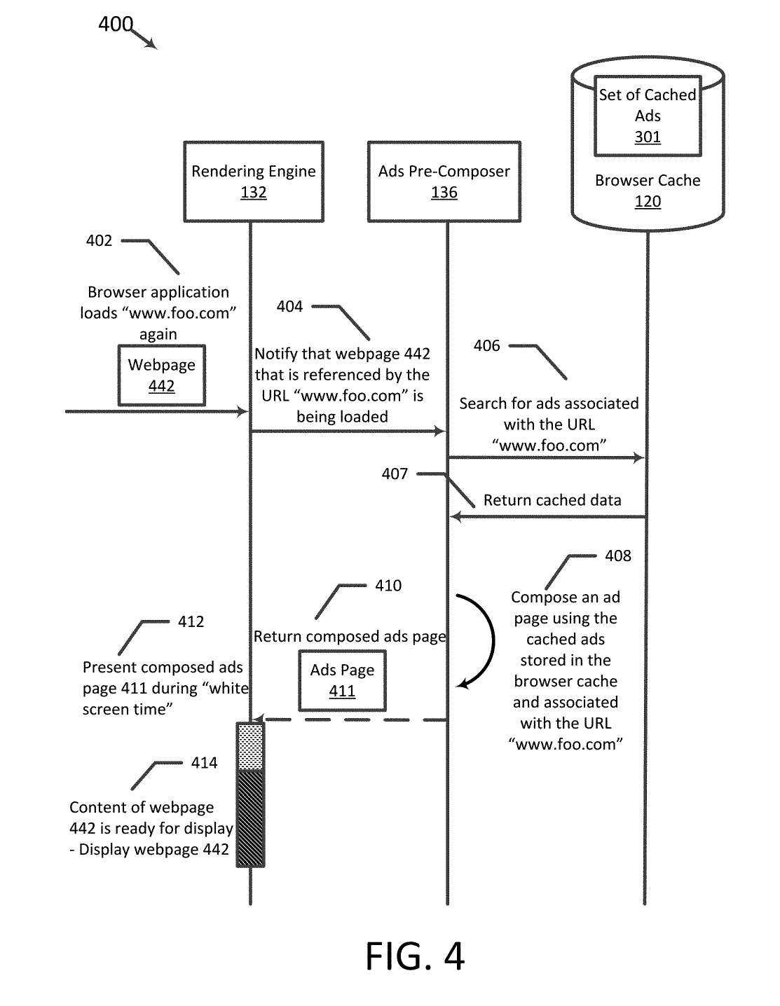

FIG. 4 is a swim diagram 400 illustrating the display of cached ads before the requested webpage is displayed on display 118 in accordance with one or more embodiments. Ads pre-composer 136 retrieves from browser cache 120 the cached ads associated with a webpage, composes the cached ads, and presents them reorganized onto display 118. In some examples, ads pre-composer 136 “pre-composes” the ads and presents them on display 118 while browser application 130 is loading the requested webpage in the background (e.g., during the conventional white screen time). Accordingly, rather than display a white screen while the webpage is loading, browser application 130 may display the cached ads to the user.

In the example illustrated in FIG. 4, at an action 402, browser application 130 loads the URL “www.foo.com” again. As shown, browser application 130 may load a webpage 442 referenced by the URL “www.foo.com.” Webpage 142 and webpage 442 may contain the same or different content. At an action 404, rendering engine 132 notifies ads pre-composer 136 that webpage 442, which is the webpage referenced by the URL “www.foo.com,” is being loaded. In the example illustrated in FIG. 4, browser cache 120 stores set of cached ads 301. Ads pre-composer 136 may be activated while a webpage load starts. At an action 406, in response to the notification, ads pre-composer 136 searches browser cache 120 for ads associated with the URL “www.foo.com.” An ad is associated with a URL if the ad was included in a webpage referenced by the URL. The ads stored in browser cache 120 were stored by ads extractor 134 or refreshed and stored by ads pre-fetcher 138 (as will be explained in more detail below).

At an action 407, cached data are transmitted from browser cache 120 to ads pre-composer 136. Ads pre-composer 136 may retrieve one or more ads previously included in a webpage referenced by the URL “www.foo.com” (e.g., ads included in webpage 142) and stored in browser cache 120.

At an action 408, ads pre-composer 136 composes an ads page using the cached ads stored in browser cache 120 and associated with the URL “www.foo.com.” The cached ads stored in browser cache 120 and associated with the URL “www.foo.com” may be the same as or different from the ads included in webpage 442. Ads pre-composer 136 may compose and lay out an ads page including the cached ads associated with the URL “www.foo.com” and stored in browser cache 120, and present the ads page during the conventional white screen time to a user. In some examples, ads pre-composer 136 blocks all live ads from being displayed in webpage 442, and optionally replaces them with cached and/or pre-fetched versions stored in browser cache 120 when the webpage is finished loading.

Ads pre-composer 136 may determine the layout of the ads page and compose the cached ads accordingly. In some examples, ads pre-composer 136 determines a layout of the ads page in accordance with a centered layout, which may provide the user with a better view of the ads compared to their original placement in the webpage. For example, the ads in the ads page may be laid out in the center of the screen rather than near the side of the screen as was originally instructed in webpage 442. In some examples, ads pre-composer 136 determines a layout of the ads page in accordance with a portrait orientation and a landscape orientation of client device 102. If user 123 is initially holding client device 102 in the portrait orientation, rendering engine 132 may display the layout of the ads page in the portrait orientation on display 118. If user 123 then flips client device 102 (e.g., mobile telephone) to the landscape orientation, rendering engine 132 may display the layout of the ads page in the landscape orientation. Other ad page layouts are within the scope of the present disclosure.

At an action 410, ads pre-composer 136 returns a composed ads page 411 to rendering engine 132. The cached ads included in ads page 411 and viewed by the user may be associated with a higher impression rate over conventional techniques. For example, user 123 is shown an ads page with only ads and may thus view the ads more closely compared to if they were displayed with non-ad content of webpage 442. Additionally, the ads displayed in ads page 411 may be laid out in a better position to catch user 123's attention (e.g., in the center of display 118) compared to positioned in a corner of the webpage with the main content.

At an action 412, rendering engine 132 presents the composed ads page 411 on display 118 during the conventional white screen time. As mentioned above, the white screen time refers herein to a time duration that starts when browser application 130 initiates loading of a webpage and ends when the webpage is rendered to display 118. In some embodiments, ads page 411 includes cached ads stored in browser cache 120 and does not include live ads that were retrieved dynamically over network 104. Accordingly, browser application 130 avoids the expense of retrieving the live ads included in webpage 442, and uses the quickly accessible ads stored in browser cache 120 and associated with the URL that references the webpage. Although the cached ads included in ads page 411 and displayed to the user may be different from those ads initially included in webpage 442, the cached ads should have a significant likelihood of being relevant to the user because the cached ads were previously included in a webpage referenced by the same URL.

Ads manager 133 may control the time duration in which ads page 411 is displayed on display 118. In this way, an ad provider may be assured that an ad is displayed for a sufficient amount of time to allow the user to view the ad before the ad is replaced with other content. In some embodiments, ads manager 133 extends the amount of time that ads page 411 is displayed. For example, even though webpage 442 is ready to be displayed on display 118, ads manager 133 may delay the display of webpage 442 until a threshold amount of time has elapsed.

At an action 414, content of the webpage is ready for display on display 118. In response to content of webpage 442 being ready for display on display 118 (and/or a threshold amount of time for which ads page 411 has been displayed on display 118 being satisfied), rendering engine 132 may display webpage 442 on display 118. Webpage 442 may replace the cached ads.

The cached ads included in ads page 411 may or may not be displayed on webpage 442. Rendering engine 132 may ignore the live ads included in webpage 442 and display the non-ad content included in the webpage on display 118. In this example, the displayed webpage is thus devoid of ad content. Accordingly, an advantage of an embodiment may provide for faster loading of the webpage because the set of live ads initially included in webpage 442 are not retrieved over network 104. Rather, the live ads originally included in webpage 442 are either replaced with ads stored in browser cache 120 or with nothing at all. Rendering engine 132 may block the set of ads included in webpage 442 from being requested from the servers storing the ad content referenced by ad URLs included in the webpage. In another embodiment, one or more cached ads of the set of cached ads included in composed ads page 411 is displayed on webpage 442 rather than the set of live ads originally included in the webpage.

In some embodiments, rendering engine 132 constructs a new webpage that includes ads page 411. In an example, ads page 411 is included in a webpage that is different from webpage 442. The webpage including ads page 411 may be replaced with webpage 442 in response to a determination that webpage 442 is ready to be displayed on display 118. In another example, rendering engine 132 renders the content of ads page 411 onto display 118 without constructing a new webpage. Rendering engine 132 may identify an ad URL and metadata of the ad (to determine the “look and feel” of the ad) and paint the ad onto display 118.

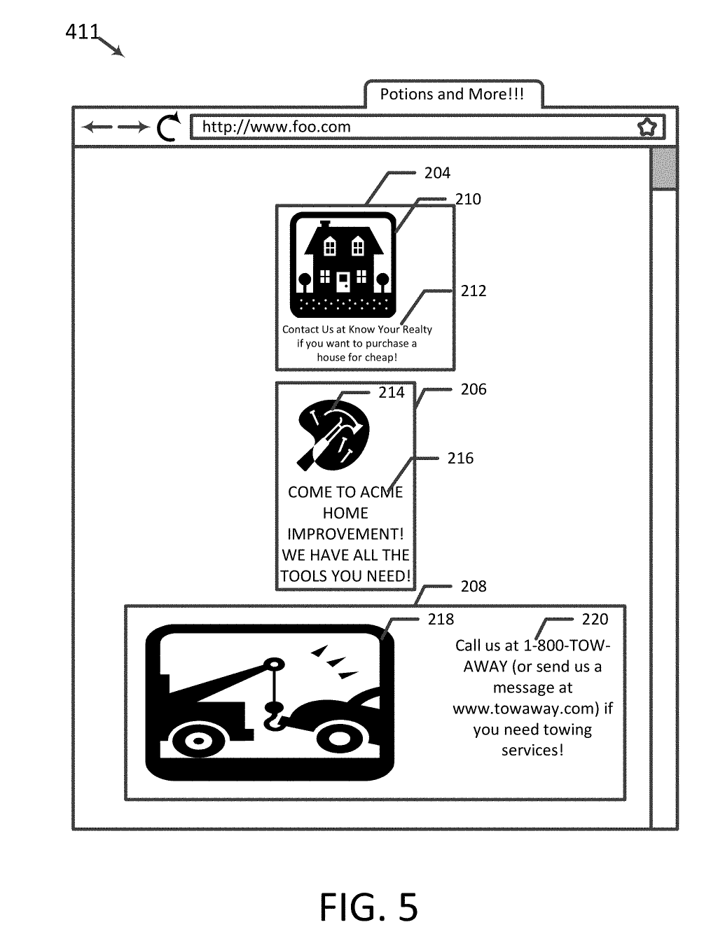

FIG. 5 is an example of composed ads page 411 illustrating the display of cached ad content on display 118 in accordance with one or more embodiments. Ads page 411 includes ads 204, 206, and 208. Although ads page 411 includes three ads, other embodiments in which an ads page includes fewer or more than three ads are within the scope of the disclosure. Rendering engine 132 displays ads 204, 206, and 208 on display 118 before displaying webpage 442 on display 118. In some examples, while webpage 442 is being rendered in the background, ads page 411 is displayed on display 118. User 123 may select one or more of these ads for more information. For example, a user may select an ad by double tapping on a location of display 118 corresponding to the ad. User 123 may select ad 204 if she is interested in the real estate market. In response to a determination that user 123 has selected ad 204, browser application 130 may load a webpage associated with ad 204, and the loaded webpage may include information about the real estate market provided by the advertiser.

Ads pre-composer 136 may compose the ads included in ads page 411 by placing the ads in the center of the ads page. The position of ads 204, 206, and 208 in ads page 411 (in FIG. 5) may be more amenable to a user's attention and viewing compared to if ads 204, 206, and 208 were positioned in their normal position on webpage 142 (see FIG. 2). Although the ads included in ads page 411 are illustrated as being in the center, ads pre-composer 136 may place the ads anywhere on ads page 411.

An embodiment of the present disclosure may have an advantage over using conventional ad blockers because if user 123 were to implement an ad blocker and request a webpage, user 123 may receive a message indicating that the ad blocker needs to be turned off before content of the webpage will be submitted to the user's device. For example, ads manager 133 may manage ads included in a webpage rather than merely blocking them outright. For example, ads manager 133 may determine when to display ads page 411, how to display the ads included in ads page 411, and when to download resources of the ads included in ads page 411. As is discussed in the present disclosure, ads manager 133 may load, store, and manage the ads included in webpages. For example, ads manager 133 does not blindly block all ads from being displayed to a user. Rather, ads manager 133 stores the “look and feel” of ads included in a webpage into browser cache 120 so that the ads can be later reconstructed and displayed to the user if a webpage that is referenced by the same URL is later requested. Additionally, an advantage of an embodiment of the disclosure may reduce the power consumption in browser application 130 because it may take less power to display colored pixels versus white pixels on display 118. Additionally, if the ads are stored in browser cache 120, it may be unnecessary to download ads included in a webpage because the ads in the ads page are managed offline.

Moreover, user 123 may avoid a white screen because ads pre-composer 136 may compose an ads page using cached ads and display the ads page. Accordingly, an advantage of an embodiment of the disclosure may provide user 123 with better use of her time. For example, rather than view a white screen until webpage 442 is loaded, user 123 may view the ads included in ads page 411 and select any of the ads of interest to the user. Further, using conventional techniques, ads 204, 206, and 208 may be displayed in the center of a browser window rather than on a side of the browser window. Accordingly, an advantage of an embodiment of the disclosure may provide advertisers with better opportunities for users to view their ads because the ads are displayed at a better location on display 118 (e.g., center of display 118 rather than at a side of the display). Advertisers may want their ads to be visible to users without scrolling the webpage. Additionally, the advertiser may have a higher impression rate because the ads have a better chance at capturing the user's attention. Moreover, the use of ads manager 133 may maintain the monetization opportunities for the ads.

In some examples, no ads associated with the URL “www.foo.com” are stored in browser cache 120. This may be the case when browser application 130 is loading the webpage referenced by the URL for the first time (or after browser cache 120 has been cleared). Ads pre-composer 136 may determine that a set of cached ads associated with the URL is stored in browser cache 120. In response, browser application 130 may request the set of ads included in the webpage (e.g., webpage 142) over a network from one or more servers storing the set of ads. Ads extractor 134 may identify these ads and store them into browser cache 120 for retrieval at a later point in time.

### C. Update the Browser Cache

### I. Refresh the Ads in the Browser Cache

The ads included in a webpage served from a server and sent to a client device may change and thus it may be desirable to update the ads stored in browser cache 120. For example, referring to FIG. 2, image 214 included in ad 206 may change. Ads pre-fetcher 138 may refresh one or more ads stored in browser cache 120 to keep the ads up-to-date. In some examples, client device 102 includes a daemon that pre-populates and searches for updates to ads stored in browser cache 120. The daemon may operate independent of the browser application. An event may trigger the daemon to search for updates to one or more ads stored in browser cache 120. For example, the daemon may periodically pre-populate and search for updates to cached ads (e.g., every hour).

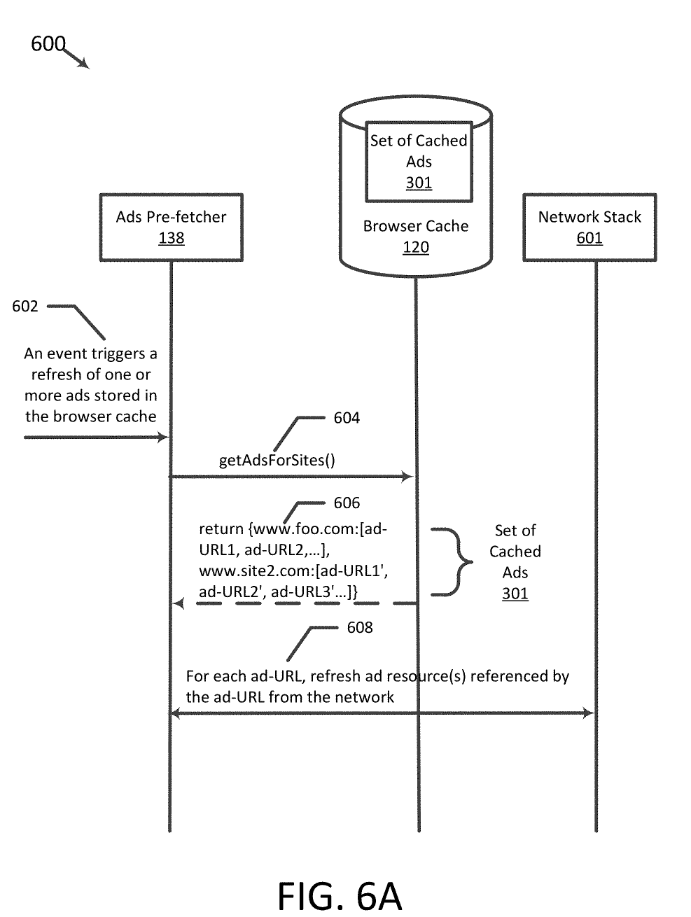

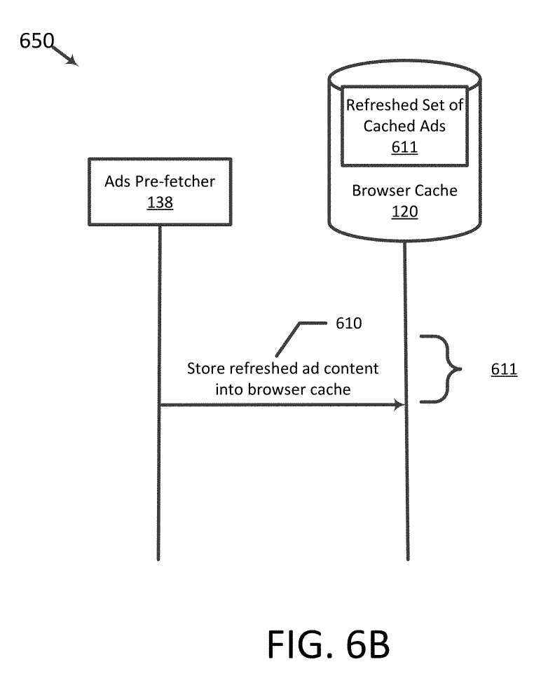

FIGS. 6A and 6B are swim diagrams 600, 650 illustrating the refreshing of ads stored in browser cache 120 in accordance with one or more embodiments. Ads pre-fetcher 138 “pre-fetches” ads corresponding to ads that are cached locally in client device 102 and based on a history of information included in received webpages (e.g., URL of a requested webpage, ad URLs, etc.). Pre-fetching an ad refers to retrieving the ad before it is actually needed for a current display in a webpage. For example, pre-fetching an ad may be performed based on an event other than inclusion of the ad in a current request for a webpage.

An event triggers a refresh of one or more ads stored in browser cache 120, and particular events that trigger the refresh may be configurable. In FIG. 6A, at an action 602, an event triggers a refresh of one or more ads stored in browser cache 120. In some examples, an event that triggers a refresh of a cached ad is time-based (e.g., a threshold amount of time elapsing). For example, ads pre-fetcher 138 may refresh one or more ads stored in browser cache 120 every day, every week, twice a month, etc. In another example, an event that triggers a refresh of a cached ad may be based on network connectivity. Ads pre-fetcher 138 may pre-fetch and cache ads periodically in the background, based on client device 102's connectivity status. For example, the triggering event may be the ads pre-fetcher 138 detecting a change in network conditions (e.g., client device 102 is connected to Wi-Fi or the 4G network), such as reaching a threshold bandwidth. Accordingly, an advantage of an embodiment may be that the refreshing of cached ads does not compete with the fetching of other webpage resources in response to a request for the webpage. That is, ads traffic will not compete with those webpage resources that were actually requested by the user. Ads may be pre-fetched in the background while client device 102's connectivity is free or abundant (e.g., Wi-Fi), potentially saving the user the expense of downloading the ads data using non-free or more constrained connectivity.

In response to detecting an event triggering a refresh of one or more ads stored in browser cache 120, ads pre-fetcher 138 may read from browser cache 120 to identify the cached ads. For example, at an action 604, ads pre-fetcher 138 invokes a “getAdsForSites( )” function, or similar, that when invoked sends a request to browser cache 120 for cached ads. At an action 606, in response to invoking the “getAdsForSites( )” function, a set of cached ads 301 retrieved from browser cache 120 is returned to ads pre-fetcher 138. The set of cached ads 301 may include the ads previously included in a webpage referenced by the URL “www.foo.com,” ads previously included in a webpage referenced by the URL “www.site.com,” etc. It should be understood that one or more ads of set of ads 301 may be returned to ads pre-fetcher 138. In some examples, for one or more ads of set of cached ads 301, ads pre-fetcher 138 identifies a set of ad URLs that references a set of ad resources of the respective ad, sends a request for the set of ad resources, and receives the set of ad resources. Ads pre-fetcher 138 may refresh one or more ads of set of cached ads 301 with one or more ads of the set of ad resources.

At an action 608, ads pre-fetcher 138 refreshes one or more ads included in set of cached ads 301. For example, for each ad URL included in set of cached ads 301, ads pre-fetcher 138 may refresh one or more ad resources referenced by the ad URL by sending a request for the one or more ad resources to network stack 601. For example, ads pre-fetcher 138 may refresh ad 206 by identifying ad 206's URL specifying where ad resources of ad 206 are stored and sending a request for the ad resources. Ad 206 includes an image 214 and text 216, and ads pre-fetcher 138 may pre-fetch one or more resources (e.g., image, text, client-side script, a self-contained iFrame, etc.) of the ad. For example, ads pre-fetcher 138 may send a first request over network stack 601 to a first server storing an image referenced by a first ad URL and a second request over network stack 601 to a second server storing text referenced by a second ad URL. The first and second ad URLs may be the same or different from each other.

In FIG. 6B, at an action 610, ads pre-fetcher 138 stores the refreshed ad content into browser cache 120. For example, ads pre-fetcher 138 may store a refreshed set of ads 611 into browser cache 120. One or more ads in refreshed set of ads 611 may be an updated version of one or more ads in set of cached ads 301 initially stored in browser cache 120. In an example, image 214 of ad 206 has changed. In this example, in response to retrieving an updated image 214′ of ad 206, ads pre-fetcher 138 may replace image 214 (see FIG. 2) with its updated version (image 214′) in browser cache 120. Ads pre-fetcher 138 may perform the above actions offline and/or separately from the other components of browser application 130 for one or more ads.

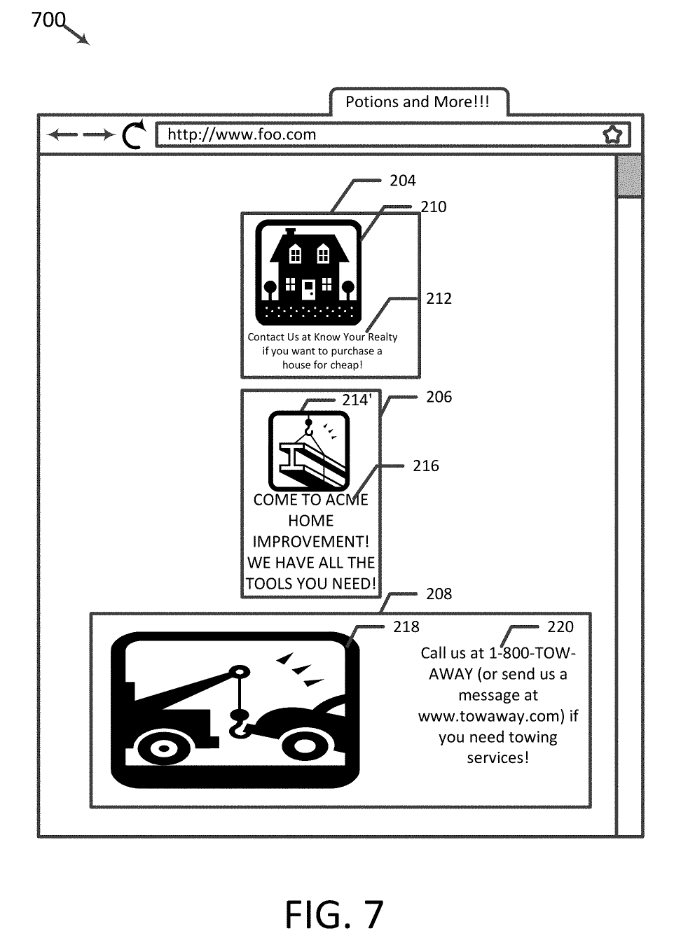

FIG. 7 is an ads page 700 illustrating the display of updated cached ad content on display 118 in accordance with one or more embodiments. Ads page 700 may be displayed in response to browser application 130 loading the URL “www.foo.com” again. In the example illustrated in FIG. 7, ads page 700 includes ads 204, 206, and 208. Ad 204 in ads pages 411 and 700 may include the same ad resources, and ad 208 in ads pages 411 and 700 may include the same ad resources. Ad 206 in ads pages 411 and 700 does not include the same ad resources. Ad 206 in ads page 700 includes an updated image 214′ and text 216. Image 214′ included in ads page 700 is an updated version of image 214 included in ads page 411. Ads pre-fetcher 138 may have pre-fetched image 214′ as discussed in reference to FIGS. 6A and 6B and stored the pre-fetched image 214′ in browser cache 120.

2. Remove the Expired Ads from the Browser Cache

Aside from refreshing the ads in browser cache 120, it may be desirable to remove stale or expired ads from browser cache 120. For example, if ad URLs stored in browser cache 120 are no longer valid, it may be desirable to identify these ad URLs and remove them from the browser cache. Ads manager 133 may implement a policy to keep browser cache 120 updated in a variety of ways. In some examples, each entry in browser cache 120 has an expiration date that is extended if data in the entry is refreshed. An entry includes an ad, and the timestamp of the entry indicates an age that the entry was last refreshed. In an example, ads manager 133 timestamps each entry in browser cache 120 with the date and time at which the ad was first stored in browser cache 120 and updates the timestamp with each subsequent refresh of the ad. Ads manager 133 may determine whether an entry in browser cache 120 has expired by determining whether the timestamp of the entry is older than a threshold amount of time (e.g., two weeks, a month, etc.), where the threshold amount of time is the age of an entry before it is considered stale. In response to a determination that the timestamp of the entry is not older than the threshold amount of time, ads manager 133 may determine that the entry has not expired.

In response to a determination that the timestamp of the entry is older than the threshold amount of time, ads manager 133 may determine that the entry has expired. If determined to be expired, ads manager 133 may purge the entry from browser cache 120. Accordingly, if an ad URL is no longer valid, ads extractor 134 may not retrieve any new data associated with the ad referenced by the ad URL and the entry including the ad URL may eventually expire and be purged from browser cache 120.

As discussed above and further emphasized here, FIGS. 1-7 are merely examples, which should not unduly limit the scope of the claims. For example, although client device 102 is described as being a mobile device, it should also be understood that in other embodiments, client device 102 may be a stationary device.

Additionally, user 123 may be interested in viewing a history of the ads previously displayed to the user. For example, user 123 may be interested in an ad that was included in an ads page but unfortunately did not select the ad before the ads page was replaced with the currently requested webpage. In some examples, ads manager 133 stores ads stored in browser cache 120 into a separate database that may be used by the user to view ads previously included in webpages. Ads manager 133 may receive a user request to view one or more ads stored in the database and retrieve the one or more ads from the database. Ads manager 133 may display the one or more ads on the display screen for the user to view. In an example, the user may perform a search (e.g., using keywords) to be provided with a dedicated view of relevant ads stored in the database. Although ads manager 133 is described as managing and storing ads in the database, it should be understood that a component that is separate from browser application 130 may perform this functionality. For example, the relevant ads may be provided by a mobile application that the user installs on client device 102 and provides with approval to access the ads included in the requested webpages. In an example, ads manager 133 stores ads in browser cache 120 and the database, and the user launches the mobile application and requests it to provide a view of particular ads on display 118.

IV. Example Method

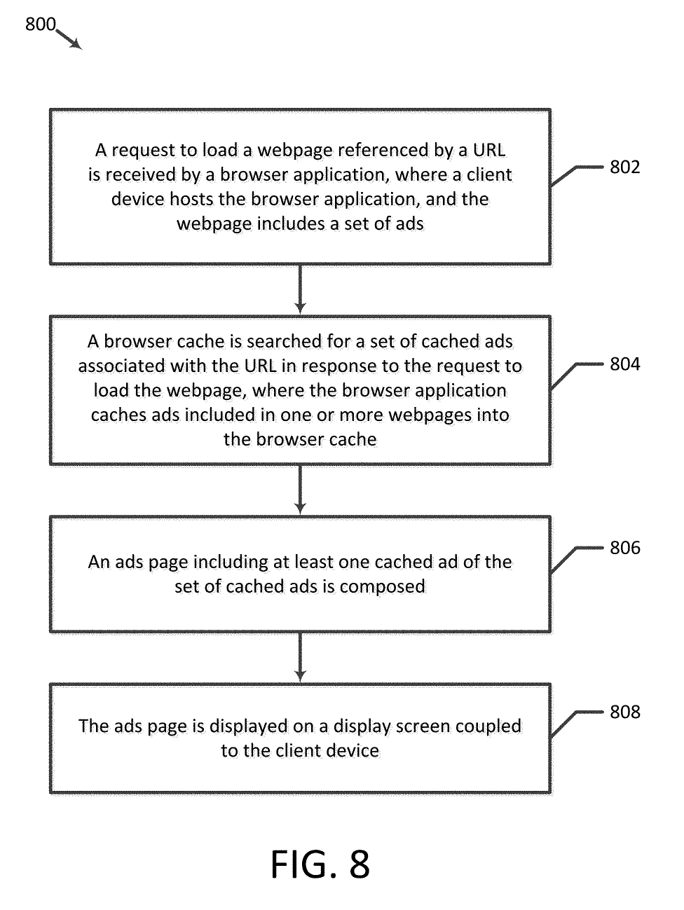

FIG. 8 is a flowchart illustrating a method 800 of managing ads in a browser application in accordance with one or more embodiments. Method 800 is not meant to be limiting and may be used in other applications.

Method 800 includes blocks 802-808. In a block 802, a request to load a webpage 442 referenced by a URL is received by browser application 130, where a client device hosts the browser application 130, and the webpage 442 includes a set of ads.

In a block 804, a browser cache is searched for a set of cached ads associated with the URL in response to the request to load the webpage, where the browser application caches ads included in one or more webpages into the browser cache. In an example, browser application 130 searches browser cache 120 for set of cached ads 301 associated with the URL “www.foo.com,” where browser application 130 caches ads 204, 206, and 208 included in previously requested webpage 142 into browser cache 120.

In a block 806, an ads page 411 including at least one cached ad 204, 206, and/or 208 stored in browser cache 120. In a block 808, the ads page 411 is displayed on a display 118 coupled to the client device 102.

It is understood that blocks 802-808 may be performed for each webpage that is loaded by browser application 130. It is also understood that additional processes may be performed before, during, or after blocks 802-808 discussed above. Moreover, one or more of the blocks of method 800 described herein may be omitted, combined, or performed in a different sequence as desired.

### V. Example Computing System

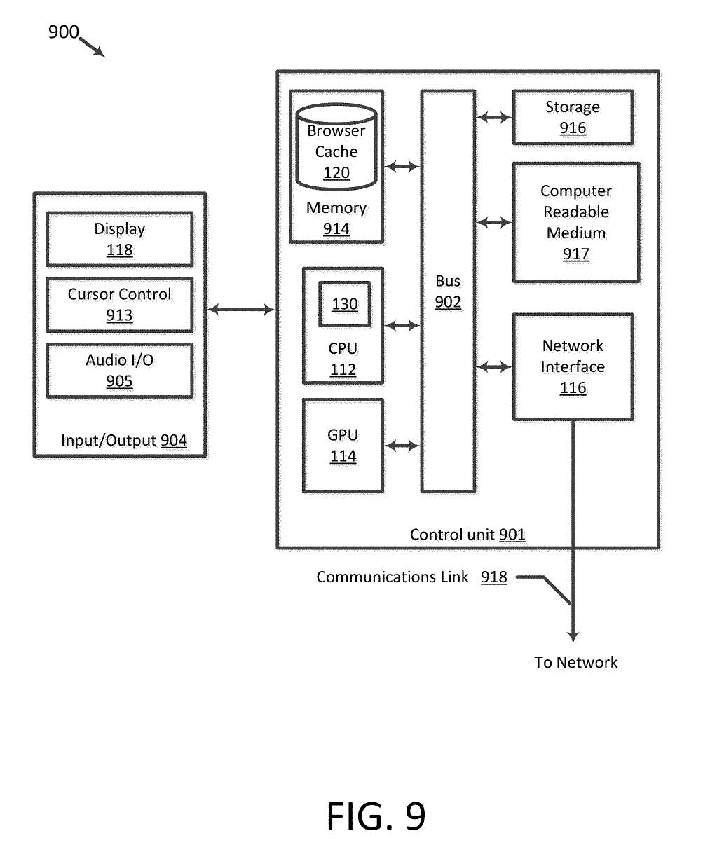

FIG. 9 is a block diagram of an example computer system 900 suitable for implementing any of the embodiments disclosed herein. In various implementations, computer system 900 may be client device 102 or server 124. In FIG. 9, computer system 900 includes a control unit 901 coupled to an input/output (I/O) component 904.

Computer system 900 may include one or more CPUs 112. Computer system 900 may additionally include one or more storage devices each selected from a group including floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read. The one or more storage devices may include stored information that may be made available to one or more computing devices and/or computer programs (e.g., clients) coupled to computer system 900 using a computer network (not shown). The computer network may be any type of network including a LAN, a WAN, an intranet, the Internet, a cloud, and/or any combination of networks thereof that is capable of interconnecting computing devices and/or computer programs in the system.

Computer system 900 includes a bus 902 or other communication mechanism for communicating information data, signals, and information between various components of computer system 900. Components include I/O component 904 for processing user actions, such as selecting keys from a keypad/keyboard, or selecting one or more buttons or links, etc., and sends a corresponding signal to bus 902. In an example, a user action may be a user input that instructs browser application 130 to request a webpage.

I/O component 904 may also include an output component such as a display 118, and an input control such as a cursor control 913 (such as a keyboard, keypad, mouse, etc.). In an example, display 118 displays an ads page (e.g., ads page 411) including one or more cached ads stored in browser cache 120. An audio I/O component 905 may also be included to allow a user to use voice for inputting information by converting audio signals into information signals. Audio I/O component 905 may allow the user to hear audio. A transceiver or network interface 906 transmits and receives signals between computer system 900 and other devices via a communications link 918 to a network. In some embodiments, the transmission is wireless, although other transmission mediums and methods may also be suitable.

CPU 112, which may be a micro-controller, digital signal processor (DSP), or other processing component, processes these various signals, such as for display on display 118 of computer system 900 or transmission to other devices via communications link 918. Browser application 130 may execute in CPU 112 and may include rendering engine 132, ads pre-composer 136, ads extractor 134, ads pre-fetcher 138. CPU 112 may also control transmission of information, such as cookies or IP addresses, to other devices.

Components of computer system 900 also include a system memory component 914 (e.g., RAM), a static storage component 916 (e.g., ROM), and/or a computer readable medium 917. A portion of memory 914 may be allocated for use as browser cache 120. Ads manager 133 may store ad resources in browser cache 120 for quicker retrieval of ads. Computer system 900 performs specific operations by CPU 112 and other components by executing one or more sequences of instructions contained in system memory component 914. In an example, CPU 112 processes instructions 802-808 according to FIG. 8.

Logic may be encoded in computer readable medium 917, which may refer to any medium that participates in providing instructions to CPU 112 for execution. Such a medium may take many forms, including but not limited to, non-volatile media, volatile media, and transmission media. In various implementations, non-volatile media include optical, or magnetic disks, or solid-state drives, volatile media include dynamic memory, such as system memory component 914, and transmission media includes coaxial cables, copper wire, and fiber optics, including wires that include bus 902. In some embodiments, the logic is encoded in computer readable medium 917. Computer readable medium 917 may be any apparatus that can contain, store, communicate, propagate, or transport instructions that are used by or in connection with CPU 112. Computer readable medium 917 may be an electronic, magnetic, optical, electromagnetic, infrared, or semiconductor device or a propagation medium, or any other memory chip or cartridge, or any other medium from which a computer is adapted to read. Further, transmission media may take the form of acoustic or light waves, such as those generated during radio wave, optical, and infrared data communications.

In various embodiments of the present disclosure, execution of instruction sequences to practice the present disclosure may be performed by computer system 900. In various other embodiments of the present disclosure, a plurality of computer systems 900 coupled by communications link 918 to the network (e.g., such as a LAN, WLAN, PTSN, and/or various other wired or wireless networks, including telecommunications, mobile, and cellular phone networks) may perform instruction sequences to practice the present disclosure in coordination with one another. In various embodiments, computer system 900 sends webpage requests to one or more servers and receives the requested webpages via network interface 116 and communications link 918.

Where applicable, various embodiments provided by the present disclosure may be implemented using hardware, software, or combinations of hardware and software. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more computer readable mediums. It is also contemplated that the application software identified herein may be implemented using one or more general purpose or specific purpose computers and/or computer systems, networked and/or otherwise. Where applicable, the ordering of various blocks or actions described herein may be changed, combined into composite blocks or actions, and/or separated into sub-blocks or sub-actions to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the present disclosure. Changes may be made in form and detail without departing from the scope of the present disclosure. Thus, the present disclosure is limited only by the claims.

What is claimed is:

1. A method of managing ads in a browser application, the method comprising:
receiving, by a browser application on a client device, a request to load a webpage referenced by a uniform resource locator (URL), the webpage including a set of ads;
searching a browser cache for a set of cached ads associated with the URL in response to the request to load the webpage, the browser application caching ads included in one or more webpages into the browser cache;
composing an ads page including at least one cached ad of the set of cached ads; and
displaying the ads page on the client device.

2. The method of claim 1, further comprising:
displaying the webpage referenced by the URL on the client device, the displayed webpage devoid of ad content, displaying the ads page including displaying the at least one cached ad before displaying the webpage.

3. The method of claim 1, wherein the further comprising:
displaying the webpage referenced by the URL, the displayed webpage including at least one cached ad of the set of cached ads, displaying the ads page including displaying the at least one cached ad before displaying the webpage.

4. The method of claim 1, further comprising:
receiving, by the browser application, a second request to load a second webpage referenced by the URL, the second request received before the first request;
parsing the second webpage associated with the second request for a second set of ads included in the second webpage; and
storing the second set of ads into the browser cache, the second set of ads associated with the URL.

5. The method of claim 4, wherein storing the second set of ads into the browser cache includes:
storing into the browser cache the URL that references the webpage, a list of ad URLs included in the second webpage, each ad URL of the list of ad URLs referencing an ad resource of the second set of ads, and metadata associated with each ad for the list of ad URLs; and
associating the URL with the list of ad URLs and the metadata.

6. The method of claim 4, further comprising:
storing the second set of ads into a database;
receiving a user request to view one or more ads stored in the database;
retrieving the one or more ads from the database; and
displaying the one or more ads.

7. The method of claim 1, wherein the further comprising:
detecting an event that triggers a refresh of one or more ads stored in the browser cache, the one or more ads including one or more ad resources;
retrieving a second set of cached ads from the browser cache; and
for one or more ads of the second set of cached ads:
sending a request for a set of ad resources referenced by a set of ad URLs of the respective ad, the respective ad including an initial set of ad resources;
receiving, by the browser application, the set of ad resources; and
refreshing one or more ads of the initial set with one or more ads of the set of ad resources.

8. The method of claim 4, further comprising:
time stamping an entry in the browser cache, the entry including an ad of the second set of ads, and the timestamp of the entry indicating an age at which the entry was last refreshed; and
if the age of an entry in the browser cache is older than a threshold amount of time, purging the entry from the browser cache.

9. The method of claim 1, further comprising:
if the set of cached ads associated with the URL is stored in the browser cache, searching the browser cache for the set of cached ads associated with the URL, composing the ads page, and displaying the ads page on the display screen; and
if the set of cached ads associated with the URL is not stored in the browser cache, requesting the set of ads over a network from one or more servers storing the set of ads included in the webpage.

10. A system for managing ads in a browser application, the system comprising:
a rendering engine that receives a request to load a webpage referenced by a uniform resource locator (URL), the webpage including a set of ads;
a browser cache that stores ads included in one or more requested webpages; and
an ads pre-composer that searches the browser cache for a set of cached ads associated with the URL and composes an ads page including at least one cached ad of the set of cached ads,
wherein the rendering engine displays the ads page on a client device.

11. The system of claim 10, wherein the rendering engine displays the webpage referenced by the URL on the client device and displays the ads page before the webpage, and wherein the displayed webpage is devoid of ad content.

12. The system of claim 10, wherein the rendering engine displays the webpage referenced by the URL on the client device and displays the ads page before the webpage, and wherein the displayed webpage includes at least one cached ad of the set of cached ads.

13. The system of claim 10, wherein the rendering engine receives a second request to load a second webpage referenced by the URL, the second request received before the first request, the system further comprising:
an ads extractor that parses the second webpage associated with the second request for a second set of ads included in the second webpage, and stores the second set of ads into the browser cache, the second set of ads associated with the URL.

14. The system of claim 13, wherein the first set of ads included in the first webpage is different from the set of cached ads included in the ads page.

15. The system of claim 10, further comprising:
an ads pre-fetcher that detects an event that triggers a refresh of one or more ads stored in the browser cache and refreshes one or more ads stored in the browser cache.

16. The system of claim 15, wherein the ads pre-fetcher detects the event in response to a threshold amount of time elapsing.

17. The system of claim 15, wherein the ads pre-fetcher detects the event in response to detecting a change in network conditions.

18. A computer-readable medium having stored thereon computer-executable instructions for performing operations, comprising:
receiving, by a browser application on a client device, a request to load a webpage referenced by a uniform resource locator (URL), the webpage including a set of ads;
searching a browser cache for a set of cached ads associated with the URL in response to the request to load the webpage, the browser application caching ads included in one or more webpages into the browser cache;
composing an ads page including at least one cached ad of the set of cached ads; and
displaying the ads page on the client device.

19. An apparatus for managing ads in a browser application, the apparatus comprising:
means for receiving a request to load a webpage referenced by a uniform resource locator (URL), the webpage including a set of ads;
means for searching a browser cache for a set of cached ads associated with the URL in response to the request to load the webpage, a browser application caching ads included in one or more webpages into the browser cache;
means for composing an ads page including at least one cached ad of the set of cached ads; and
means for displaying the ads page on a client device.
